(19) United States
(12) Patent Application Publication
(10) Pub. No.: US 2025/0317241 A1
(43) Pub. Date: Oct. 9, 2025

(54) RADIO LINK CONTROL LAYER TECHNOLOGIES FOR RETRANSMISSION OF PACKETS

(71) Applicant: Apple Inc., Cupertino, CA (US)

(72) Inventors: Ping-Heng Kuo, London (GB); Ralf Rossbach, Munich (DE); Peng Cheng, Beijing (CN); Alexander Sirotkin, Tel Aviv (IL); Fangli Xu, Beijing (CN); Naveen Kumar R. Palle Venkata, San Diego, CA (US); Zhibin Wu, Los Altos, CA (US); Yuqin Chen, Beijing (CN); Haijing Hu, Los Angeles, CA (US)

(73) Assignee: Apple Inc., Cupertino, CA (US)

(21) Appl. No.: 19/071,589

(22) Filed: Mar. 5, 2025

Related U.S. Application Data
(60) Provisional application No. 63/575,423, filed on Apr. 5, 2024.

(51) Int. Cl. H04L 1/08; H04L 5/00; H04W 28/06; H04W 76/20

(52) U.S. Cl. CPC H04L 1/08; H04L 5/0053; H04W 28/06; H04W 76/20

(57) ABSTRACT

The present application relates to devices and components, including apparatus, systems, and methods for configuring the retransmission counter in the radio link control layer.

### CROSS-REFERENCES TO OTHER APPLICATIONS

This application claims priority to U.S. Provisional Application No. 63/575,423, for “RADIO LINK CONTROL LAYER TECHNOLOGIES FOR RETRANSMISSION OF PACKETS” filed on Apr. 5, 2024, which are herein incorporated by reference in their entirety for all purposes.

### TECHNICAL FIELD

This application relates generally to communication networks and, in particular, to configuring the retransmission counter in radio link control (RLC) acknowledgment mode (AM).

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates aspects of a user equipment in further detail in accordance with some embodiments.

FIG. 3 illustrates a timing diagram in accordance with some embodiments.

FIG. 4 illustrates a radio link control signal flow diagram in accordance with some embodiments.

FIG. 5 illustrates data flow in accordance with some embodiments.

FIG. 6 illustrates aspects of a transmitting entity in accordance with some embodiments.

FIG. 7 illustrates aspects of a transmitting entity in accordance with some embodiments.

FIG. 8 illustrates another operation flow/algorithmic structure in accordance with some embodiments.

FIG. 9 illustrates retransmission configuration in accordance with some embodiments.

FIG. 10 illustrates another operation flow/algorithmic structure in accordance with some embodiments.

FIG. 11 illustrates another operation flow/algorithmic structure in accordance with some embodiments.

FIG. 12 illustrates another operation flow/algorithmic structure in accordance with some embodiments.

FIG. 13 illustrates a user equipment in accordance with some embodiments.

FIG. 14 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, memory interface, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

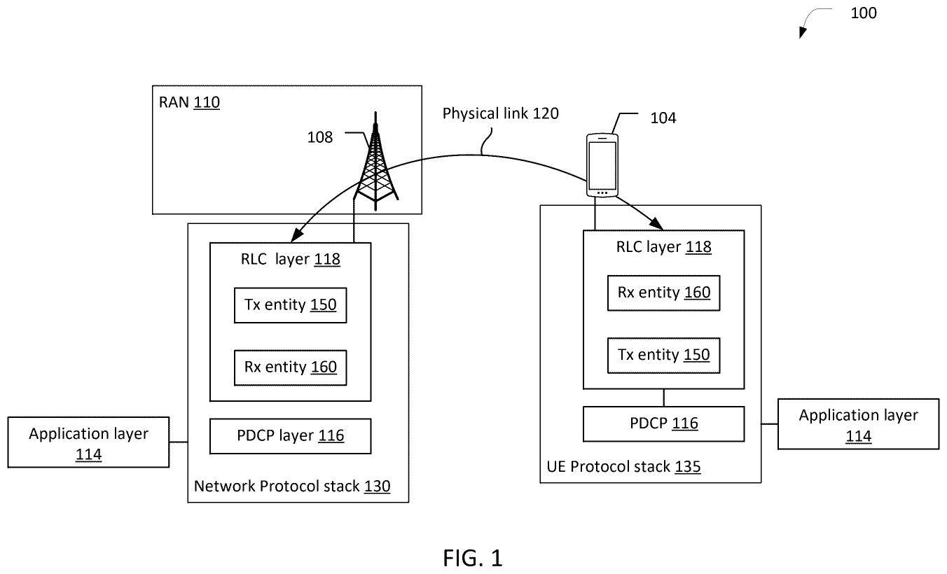

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The 3GPP TSs may define a protocol stack, e.g., network protocol stack 130 or UE protocol stack 135. The protocol stack may be a set of communication protocols. In some examples, the protocol stack may be designed in a layered architecture for modularity, with each layer providing specific functions. The design may allow changes in one layer without affecting others, facilitating upgrades and improvements. The layers may include a physical layer (Layer 1, L1, or PHY) responsible for establishing and maintaining a physical link 120. Bits of control and data may transmit over the air interface and the physical link 120. The protocol stack, e.g., network protocol stack 130 or UE protocol stack 135, may include a data link layer (Layer 2, L2), which may be divided into a medium access control (MAC), a radio link control (RLC) 118, and a packet data convergence protocol (PDCP) 116 sub-layers. Layer 2 may be responsible for managing the UE 104 connectivity and movement between cells and networks. In some instances, application layer 114 is not included in the protocol stack.

The RLC 118 sub-layer may be responsible for reliable data transmission. The RLC 118 may include a transmitting entity 150 and a receiving entity 160. The transmitting entity 150 at the transmitting end may segment the data from higher layers, e.g., PDCP layer 116 or application layer 114, and add sequence numbers and headers. These packets may then be transmitted over the air interface, e.g., via the physical link 120. At the receiver end, the receiving entity 160 of the RLC layer 118 may reassemble the packets back into the original data, e.g., using the sequence numbers and header information to ensure correct order and to detect any missing packets. If a packet is detected as missing or erroneous, the RLC layer 118 at the receiver can request retransmission from the transmitter.

In the downlink transmission, the base station 108 is the transmitting end, and the UE 104 is the receiving end. The transmitting entity 150 of the RLC 118 of the base station 108 sends the packets via the physical link 120 to the UE 104. The receiving entity 160 of the RLC layer 118 of the UE 104 receives and reassembles the packets. In some embodiments, the packet transmitted by an RLC layer 118 may be referred to as an RLC protocol data unit (PDU).

The receiving entity 160 of RLC layer 118 of the base station 108 may be called a peer entity to the transmitting entity 150 of RLC layer 118 of the UE 104. Similarly, the receiving entity 160 of RLC layer 118 of the UE 104 may be called a peer entity to the transmitting entity 150 of RLC layer 118 of the base station 108.

In some instances, a packet received by a layer from higher layers is called the service data unit (SDU) of that layer. The packet transmitted by the layer to lower layers is called the PDU of that layer. For example, packets received to PDCP layer 116 are called PDCP SDUs, and packets sent from PDCP layer 116 to RLC layer 118 are called PDCP PDUs.

The RLC layer 118 may be configured as an acknowledgment mode (AM) RLC. In AM RLC, each transmitted PDU is assigned a sequence number. The receiver may send acknowledgments (ACKs) for correctly received PDUs and negative acknowledgments (NACKs) for missing or erroneous PDUs. Upon receiving a NACK, or in the absence of an ACK associated with a PDU, the transmitter may retransmit the corresponding PDU.

In some embodiments, the application layer 114 may generate packets and group them in PDU sets. The PDCP layer 116 may receive the packets and generate PDCP PDUs. Each PDCP PDU may be associated with one or more application layer packets or a PDU set. The RLC layer 118 may receive the PDCP PDUs and generate RLC PDUs. Each RLC PDU may be associated with one or more PDCP PDUs and similarly may be associated with one or more application layer packets or a PDU set.

In some embodiments, when a PDCP SDU is received from the upper layer, the transmitting PDCP entity may start a discard timer. The discard timer may track the buffered time of each SDU at the PDCP layer 116. In some instances, when the discard timer expires for a PDCP SDU or the successful delivery of the PDCP SDU is confirmed, e.g., via an ACK, the transmitting PDCP entity may discard the PDCP SDU along with the corresponding PDCP PDU.

In some instances, discarding PDCP SDUs that are not successfully delivered may cause the retransmission of the entire PDU set associated with the discarded PDCP SDUs. Transmission or retransmission of the entire PDU set associated with already discarded PDCP SDUs may be unnecessary and inefficient, waste network resources, increase latency, and/or negatively impact the user experience. It is desirable to prevent PDCP SDU discarding due to discard timer expiry.

In some embodiments, when RLC PDUs are delivered to lower layers for transmissions, a copy of the RLC PDU may be buffered for retransmission. The RLC PDU may remain in the retransmission buffer until the receiver side of the RLC receives an ACK or a NACK associated with the RLC PDU. The RLC PDU is removed from the retransmission buffer if an ACK is received. However, if a NACK is received, the transmitting side of the RLC may retransmit the RLC PDU. In some instances, the RLC PDUs in the retransmission buffer may stall or prevent the initial transmission of new RLC PDUs. In some instances, when a packet becomes delay-critical, many other packets belonging to the same PDU set may also become delay-critical. Thus, it is desirable that the transmission and retransmission buffers are not stalled.

In AM RLC (sometimes may be called RLC AM), some RLC SDUs or SDU segments can be considered for retransmission. For example, when the peer RLC entity does not positively acknowledge an RLC SDU, the AM RLC may consider that RLC SDU (or SDU segment) for retransmission.

To prevent infinite retransmissions of the same RLC SDU or its segments, the RLC may configure and associate a retransmission counter to each RLC SDU considered for retransmission. In some embodiments, when a negative acknowledgment is received for an RLC SDU or its segment for the first time, the retransmission counter is initialized to 0 for the first retransmission. The retransmission counter is incremented for each subsequent retransmission of the same RLC SDU or its segments. When the retransmission counter reaches a predefined threshold, e.g., maximum retransmission threshold, the RLC layer is notified that the maximum retransmission limit for that SDU or SDU segment has been reached.

When an RLC SDU is considered delay-critical, it may have a shorter remaining time until discarding than non-delay-critical SDUs. Therefore, a delay-critical SDU may be discarded before being retransmitted for as many as the maximum retransmission threshold. However, the RLC transmitting entity 150 may continue retransmitting a delay-critical SDU after being discarded and until the retransmission counter reaches the maximum retransmission threshold. Transmission of a discarded SDU may waste network resources and reduce the efficiency and utility of the wireless network. It is desirable to avoid excessive retransmission of an RLC SDU that is considered delay-critical. In one embodiment, the network may configure the retransmission timer of a delay-critical RLC SDU with a smaller limit for the maximum number of retransmissions than that of non-delay-critical RLC SDUs.

In some embodiments, the AM RLC entity, e.g., transmitting entity 150, may determine if an RLC SDU considered for retransmission is a delay-critical RLC SDU. Suppose the RLC SDU is not delay-critical. In that case, the legacy behavior may be applied, where the retransmission is performed until the positive acknowledgment is received or the retransmission number reaches the first threshold. If the RLC SDU is delay-critical, the retransmission is performed until the positive acknowledgment is received or when the number of retransmissions reaches a second threshold different from the first threshold.

In some embodiments, whether the second threshold is applied to the delay-critical RLC SDUs may depend on one or more conditions, such as whether congestion is detected or importance-based discarding is activated.

In some embodiments, the transmitting entity 150 may determine or select the maximum retransmission threshold for the RLC SDUs based on the discarding timer of the associated PDCP SDU or the remaining time until the discarding of the associated PDCP SDU.

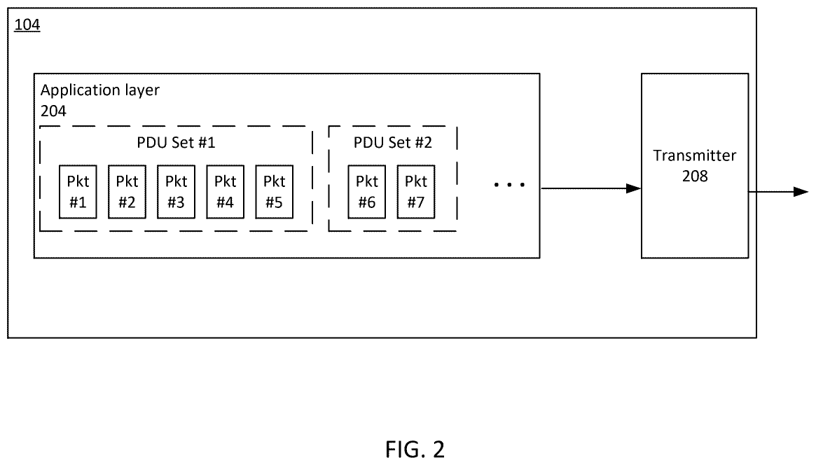

FIG. 2 illustrates aspects of the UE 104 in further detail in accordance with some embodiments. The UE 104 may include an application layer 204 that generates application traffic to be transmitted to another device through the network environment 100. In some embodiments, the application layer 204 may have an XR application that generates XR traffic. However, embodiments are not limited to XR use cases.

For XR and other services, the application layer 204 may generate PDU sets, with individual PDU sets comprising one or more packets. A packet, also referred to as a PDU, may be an Internet protocol (IP) packet or a non-IP packet. As shown, PDU set #1 may include packets #1-#5, while PDU set #2 includes packets #6 and #7. Each PDU set may be mapped to a different QoS flow. Different PDU sets may be mapped to different traffic flows when they correspond to different traffic flows or modalities.

The packets of a PDU set may carry a payload of one unit of information generated by the application layer. The unit of information may be a frame or video slice for XR Services, such as those defined in 3GPP Technical Report (TR) 26.926 v18.1.0 (2024-01), for example. In some implementations, all PDUs in the PDU Set may be needed by an application layer at a destination node to allow the application layer to recover parts or all of the information unit. In other implementations, the application layer on the destination node may still be able to recover parts or all of the information unit, even if some PDUs of a PDU set are missing.

In some embodiments, the data produced by an application layer of the UE 104 may include multi-modal data. Multi-modal data may include input data from different devices/sensors or output data to different destinations (e.g., one or more UEs) desired for the same task or application. Multi-modal data may include more than one single-modal data (e.g., one type of data), and there may be a strong dependency among each single-modal data associated with multi-modal data.

In some embodiments, the data produced by an application layer may be in a data burst. A data burst may include, for example, data produced by the application layer in a short period of time. The data burst may include PDUs from one or more PDU Sets.

The PDU sets may be provided to a transmitter 208 of the UE 104. The transmitter 208 may be configured to execute a communication protocol stack, for example, UE protocol stack 135 of FIG. 1, to facilitate communication via the network environment 100. The transmitter 208 may implement L2 and L1 functionality. At the L2 level, transmitter 208 may include a service data adaptation protocol (SDAP) layer, a PDCP layer, an RLC layer, and a MAC layer. At the L1 level, the transmitter 208 may include a physical (PHY) layer. Briefly, the SDAP layer may manage QoS flow handling between the QoS flows and the data radio bearers (DRBs). The PDCP layer may manage robust header (de) compression and security between DRBs and RLC channels. The RLC layer may manage (re-)segmentation and error correction through automatic repeat requests (ARQ) between logical channels and RLC channels. The MAC layer may manage scheduling/priority handling, (de)multiplexing, and hybrid automatic repeat request (HARQ) processes between logical channels and transport channels. The PHY layer may manage the processing of the physical data and control channels.

In some embodiments, various information may be provided by the core network node to the RAN 110 to assist in handling QoS flows and PDUs. This information may be consistent with that described in 3GPP TR 23.700-60 v18.0.0 (2022-12-21). This information may include semi-static information for both uplink and downlink, PDU set QoS parameters, and dynamic information for downlink.

The semi-static information for both uplink and downlink may be provided via the control plane (NGAP). This information may include periodicity for uplink and downlink traffic of the QoS Flow via time-sensitive communications assistance information (TSCAI)/time-sensitive communications assistance container (TSCAC); and traffic jitter information (e.g., jitter range) associated with each periodicity of the QoS flow.

The PDU set QoS parameters may include a PDU Set Error Rate (PSER) to define an upper bound for the rate of PDU Sets that have been processed by the sender of a link layer protocol but that are not successfully delivered by the corresponding receiver to the upper layer. See, for example, 3GPP TR 23.700-60. In some instances, a PDU set may be considered as successfully delivered when all PDUs of a PDU Set are delivered successfully. In other instances, other definitions of successful delivery may be made. In some instances, if one PDU of a PDU set is discarded, all remaining PDUs of the PDU set may be discarded.

The PDU set QoS parameters may further include a PDU Set Delay Budget (PSDB) that defines a time between the reception of a first PDU and the successful delivery of a last-arrived PDU of a PDU Set. See, for example, 3GPP TR 23.700-60. The PSDB may be an optional parameter in various embodiments.

The PDU set QoS parameters may further include a PDU Set importance (PSI) to indicate the relative importance of a PDU set compared to other PDU sets within the same QoS flow.

A PDU set may be associated with the following information: a PDU set sequence number (SN); a PDU set size (in bytes); a PDU SN within a PDU Set; an end PDU of the PDU Set indication; a PDU set importance (PSI); and an end of data burst indication in the header of a last PDU of the data burst. The PSI may be used to identify the importance of a PDU Set within a QoS flow. The RAN 110 may use the PSI for PSI-based discarding in the presence of congestion, as described herein.

The application, application server, application function, or application layer 114 may assign a PSI level for each packet or PDU set or may define rules and policies for assigning a PSI level to a type of packet or PDU set. For example, the application may assign a PSI level to packets associated with audio data and a different PSI to packets or PDU sets associated with real-time video data. The application may assign different PSI to payloads associated with different video frame types within a video stream. PSI level selection may be influenced by factors such as type of application (e.g., video, audio, text), details of codec (e.g., H.264 or high-efficiency video coding, HEVC), level of error propagation when a PDU set is discarded, or inter-dependency among PDU sets (e.g., whether a PDU set is necessary for the processing of some other PDU sets). The PSI selection may be similar to that described in 3GPP TS 26.522 v 0.4.0 (2024-03-01).

PSI may have N levels, e.g., levels 0 to N−1. The higher PSI level values may be associated with less importance. Some of the PSI levels may indicate no interdependency with other PDU sets. For example, there may be 16 levels of PSIs, e.g., level 0 to level 15. PSI levels 14 and 15 may indicate no inter-dependency to other PDU sets; e.g., a PDU set having PSI level 14 may not have inter-dependency to other PDU sets. PDU sets with other PSI levels, e.g., levels 0 to 13, may be needed to process other PDU sets. These values may differ in other embodiments. The identification of the importance level or PSI of a PDU Set, or the determination of whether a packet is considered to be less important (e.g., based on means other than PSI), may be up to implementation.

In some instances, the base station 108 may instruct the UE 104 to apply different discarding timers for PDU sets with different PSIs. For example, packets belonging to a PDU set with a sufficiently large PSI level (e.g., considered to be less important) may have a shorter discard timer than a default discard timer, while packets belonging to other PDU sets with a lower PSI level (e.g., not considered to be less-important) may be processed based on the default discard timer. This mechanism may be called PSI-based discarding or importance-based discarding, which could be configured and activated or deactivated on each individual data radio bearer (DRB).

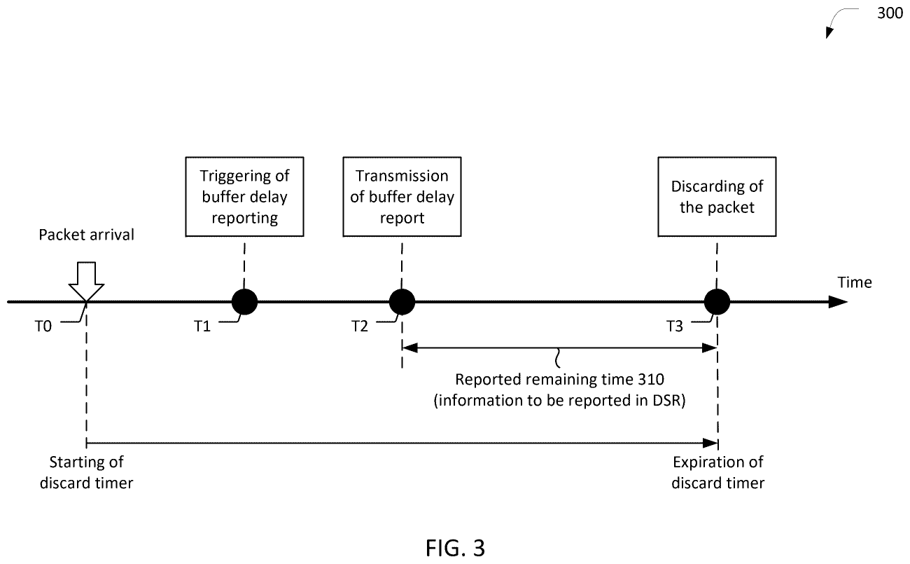

FIG. 3 illustrates a timing diagram 300 for generating and transmitting a delay status report in accordance with some embodiments. The delay status reporting (DSR) may assist in delay-aware scheduling. A DSR may be triggered when the remaining time till the data is discarded is below a threshold.

At T₀, a buffer of a transmitting entity (e.g., UE PDCP transmitting entity in uplink transmission or base station PDCP transmitting entity in downlink transmission) and associated with a logical channel (LCH) or a logical channel group (LCG) can receive a data packet for transmission. At T₀, the transmitting entity can start a discard timer, in which it will discard the data if, by expiration of the timer, the transmitting entity has not successfully transmitted the data packet. At T₁, a first time interval (e.g., T₃−T₁) is reached, where the time remaining prior to the expiration of the discard timer has reached a threshold, such that a delay status report (DSR) is triggered. At T₂, a DSR report is generated and transmitted. The DSR can include data volume information. For example, the DSR may include the buffer size or a reported remaining time 310 when the DSR is transmitted. The reference point for measuring the reported remaining time 310 may be the transmission of DSR. UE may report the DSR in a MAC control element (CE).

As mentioned above, DSR may include buffer size. The UE may determine the buffer size through data volume calculation. 3GPP TS 38.323 v. 18.0.0 (2024-01) describes data volume calculation for delay status reporting.

3GPP TS 38.323 introduces delay-critical PDCP SDUs to calculate buffer size for the DSR. Similarly, 3GPP TS 38.322 v. 18.0.0 (2024-01) introduces delay-critical RLC SDUs to calculate buffer size for DSR.

The delay-critical PDCP SDU may be defined as a PDCP SDU for which the remaining time till discarding is less than a first threshold when PDU set discarding is not configured. When the PDU set discarding is configured, a PDCP SDU is delay-critical if it belongs to a PDU set in which at least one PDCP SDU has the remaining time till discarding less than a second threshold. Note that the remaining time till discarding is the actual remaining time of the discard timer, whereas the reported remaining time 310 is the remaining time on the discard timer at the time of generating or transmitting the DSR. Similarly, a delay-critical RLC SDU is defined as an RLC SDU corresponding to a PDCP PDU indicated as delay-critical by PDCP.

In some instances, for the purpose of MAC delay status reporting, the transmitting PDCP entity may be considered as delay-critical PDCP data volume: 1) the delay-critical PDCP SDUs for which no PDCP Data PDU have been constructed; 2) the PDCP Data PDU that contain the delay-critical PDCP SDUs and have not been submitted to lower layers; 3) the PDCP Control PDUs; 4) for AM data radio bearers (DRBs), the PDCP SDUs to be retransmitted; and 5) for AM DRBs, the PDCP Data PDUs to be retransmitted.

In some instances, for the purpose of MAC buffer status reporting, the UE may consider the following as RLC data volume: 1) RLC SDUs and RLC SDU segments that have not yet been included in an RLC data PDU; 2) RLC data PDUs that are pending for initial transmission; and 3) RLC data PDUs that are pending for retransmission (RLC AM). Additionally, the UE may also consider the following as delay-critical RLC data volume: 1) delay-critical RLC SDUs and delay-critical RLC SDU segments that have not yet been included in an RLC Data PDU; 2) RLC Data PDUs pending for initial transmission and containing a delay-critical RLC SDU or a delay-critical RLC SDU segment; and 3) RLC Data PDUs that are pending for retransmission (RLC AM). In addition, if a status PDU has been triggered and a prohibition timer, t-StatusProhibit, is not running or has expired, the UE may estimate the size of the status PDU that will be transmitted in the next transmission opportunity and consider this as part of RLC data volume for MAC buffer status reporting and as part of delay-critical RLC data volume for MAC delay status reporting.

In some embodiments, an identifier associated with an RLC SDU may indicate whether it is delay-critical, e.g., a one-bit indicator. RLC PDUs may be considered delay-critical if they are associated with delay-critical RLC SDUs or delay-critical RLC SDU segments. RLC Data PDUs of both initial transmission or retransmission may be considered as delay-critical.

In some embodiments, an RLC SDU or SDU segment may be associated with a parameter associated with the discard timer or the PDCP SDU associated with the RLC SDU or SDU segment. The parameter may include a value of the remaining time till discarding, e.g., the remaining time till the discard timer expires.

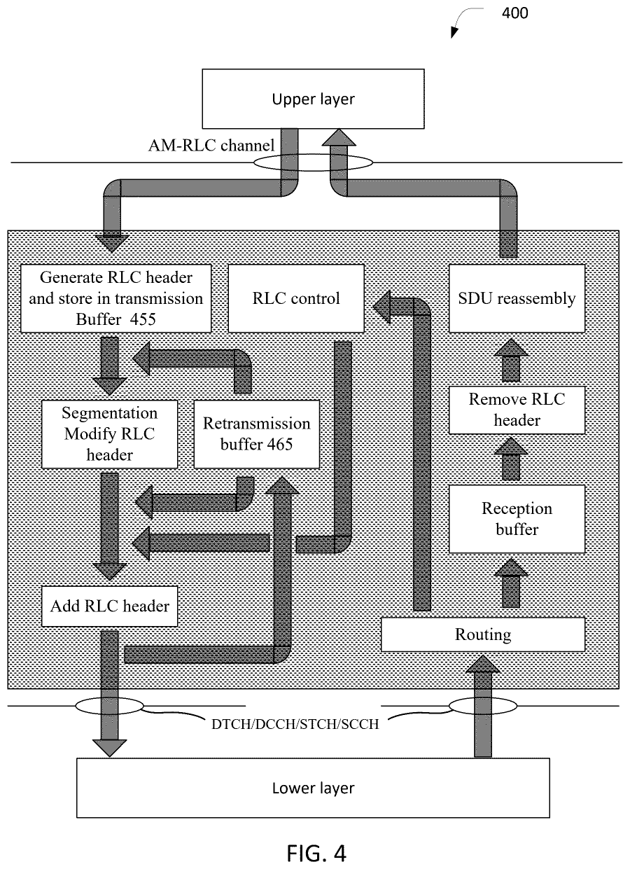

FIG. 4 illustrates an RLC signal flow diagram 400 in accordance with some embodiments. Signal flow diagram 400 is an example of functionalities performed by the RLC layer, e.g., RLC layer 118 in FIG. 1.

An example of an AM RLC entity is described in 3GPP TS 38.322. An AM RLC entity may be configured to submit or receive RL CPDUs through the following logical channels: downlink (DL) or uplink (UL) dedicated control channel (DCCH), DL or UL dedicated traffic channel (DTCH), sidelink control channel (SCCH), and sidelink traffic channel (STCH).

An AM RLC entity may deliver or receive the following RLC Data PDUs: AMD PDU. An AMD PDU may contain either one complete RLC SDU or one RLC SDU segment. An AM RLC entity may deliver or receive the following RLC control PDU: status PDU. The status PDU may be used to provide the status of the PDUs that are correctly received and lost during transmission. It is sent from the RLC receiving entity, e.g., receiving entity 160 in FIG. 1, to the transmitting entity, e.g., transmitting entity 150 in FIG. 1. The status PDU may contain an ACK or NACK sequence number.

The transmitting side of an AM RLC may generate AMD PDU(s) for each RLC SDU. Upon receiving a transmission opportunity from the lower layer, the transmitting side of the AM RLC entity may break down the RLC SDUs into segments. This is done so that the resulting AMD PDUs, with appropriately updated RLC headers, can fit within the total size of the RLC PDU(s) specified by the lower layer.

The transmitting side of an AM RLC entity may also support the retransmission of RLC SDUs or RLC SDU segments. If the RLC SDU or RLC SDU segment to be retransmitted (including the RLC header) exceeds the total size of the RLC DU(s) specified by the lower layer at a given transmission opportunity, the AM RLC entity may break down the RLC SDU into segments or resegment the RLC SDU segments into smaller segments.

When the AM RLC entity on the receiving end receives AMD PDUs, it may identify if there are any duplicated AMD PDUs and discard them. The AM RLC may also recognize if any AMD PDUs have been lost at lower layers and ask its peer AM RLC entity for retransmission. Finally, the AM RLC may reassemble the RLC SDUs from the AMD PDUs it received and pass the RLC SDUs to the upper layer as soon as they are ready.

AM RLC may include two buffers. The first buffer may be the transmission buffer 455. The transmission buffer 455 may store RLC AMD PDUs. After an RLC PDU has been transmitted, a similar copy is stored in the retransmission buffer 465, the second buffer. If the RLC receives a NACK or does not get any positive response, the RLC PDU from the retransmission buffer may be transmitted again.

In some instances, the RLC SDUs are included in RLC PDUs and submitted to a lower layer for transmission. The RLC protocol may track RLC SDUs that have been submitted for transmission and decide to retransmit a buffered RLC PDU based on the associated RLC SDUs.

The transmitting side of an RLC transmitting entity, e.g., transmitting entity 150, may solicit a status PDU from its peer entity at the receiving side. For example, the transmitting entity 150 of the base station 108 may solicit a status PDU from the receiving entity 160 of the UE 104, or the transmitting entity 150 of the UE 104 may solicit a status PDU from the receiving entity 160 of the base station 108.

The transmitting side may solicit a status PDU from its peer entity through the header of an AMD PDU. The transmitting side of a transmitting entity 150 may set a polling flag in the header of an AMD PDU sent to the peer receiving entity 160 and received by the receiving side of the peer receiving entity 160. The transmitting side may set the polling flag when the total number of PDUs transmitted since the last poll or status report (parameter: PDU_WITHOUT_POLL) is equal or greater than a threshold, e.g., the configured pollPDU threshold; when the total number of bytes of the RLC PDUs transmitted since the last poll or status report is received (BYTE_WITHOUT_POLL) is greater than or equal to another threshold, e.g., the configured pollByte threshold; when the transmission and retransmission buffer becomes empty (including transmitted RLC SDUs or RLC SDU segments awaiting acknowledgments) after the transmission of the current AMD PDU; when no new RLC SDU can be transmitted after the transmission of the AMD PDU, e.g., due to window stalling; or when the poll retransmit timer expires. Once the polling flag is set, a status PDU from the receiving side is solicited. This mechanism may allow the transmitting side to request its peer to send the current status.

Once the polling flag is set, e.g., by setting the poll bit to ‘1’ in an AMD PDU, the transmitting side may start or restart a poll retransmit timer. For example, the transmitting side may start a configured t-PollRetransmit timer. The timer is stopped when a status PDU is received. If the timer expires, the transmitting side may initiate data retransmission or retransmit the poll.

In some instances, the receiving side may determine which PDUs to report based on the sequence numbers (SNs) and segment offsets (SOs) of the received AMD PDUs. The report may be a control PDU, e.g., status PDU. The receiving side may generate the status report and include the SNs of the received PDUs and the SNs of the lost PDUs or segments. TS 38.322 describes RLC AM polling and associated operations and timers, e.g., the t-PollRetransmit timer.

In some instances, the transmitting side of an AM RLC entity may maintain a transmitting window. The transmitting window may provide orderly transmission of AMD PDUs. It may be used to control the number of PDUs that can be transmitted before receiving an acknowledgment. Two parameters may determine the transmitting window: 1) parameter “AM_Window_Size,” which is the size of the window in terms of the number of PDUs, and 2) parameter TX_Next_Ack, which is the sequence number of the next RLC SDU for which a positive acknowledgment is expected to be received in-sequence. If an AMD PDU has a sequence number, PDU_SN, that is greater than or equal to the TX_Next_Ack and smaller than Tx_Next_Ack+AM_Window_Size, the AMD PDU may be transmitted.

The Tx_Next_Ack may serve as the lower edge of the transmitting window. The Tx_Next_Ack+AM_Window_Size may serve as the upper edge of the transmitting window. A new RLC SDU with SN outside the transmitting window cannot be transmitted. Therefore, it is desirable for the transmitting window to move forward as quickly as possible. When the transmitting window moves forward, the subsequent new packets are less likely to be delayed by window stalling. The transmitting window will move forward by receiving ACK for PDUs with SN equal to Tx_Next_Ack. The transmitter may proactively request ACK or NACK, e.g., via a polling mechanism from the receiver side.

In some instances, some RLC SDUs (or their segments) may be considered for retransmission. For example, when the peer RLC entity does not positively acknowledge some RLC SDUs. Retransmission of an RLC SDU may be performed several times before it is positively acknowledged. In some instances, the number of retransmissions may be capped by a threshold, e.g., configured threshold maxRetxThreshold.

When an RLC SDU or an RLC SDU segment is considered for retransmission, a counter, e.g., configured RETX_COUNTER, may be assigned to the RLC SDU or RLC SDU segment that is being retransmitted. If the RLC SDU or RLC SDU segment is being considered for retransmission for the first time, the counter is set to zero, e.g., RETX_COUNT=0. The counter may be incremented if the RLC SDU or its segment is not pending for retransmission and the RETX_COUNT associated with the RLC SDU has not been incremented due to another NACK in the same status PDU.

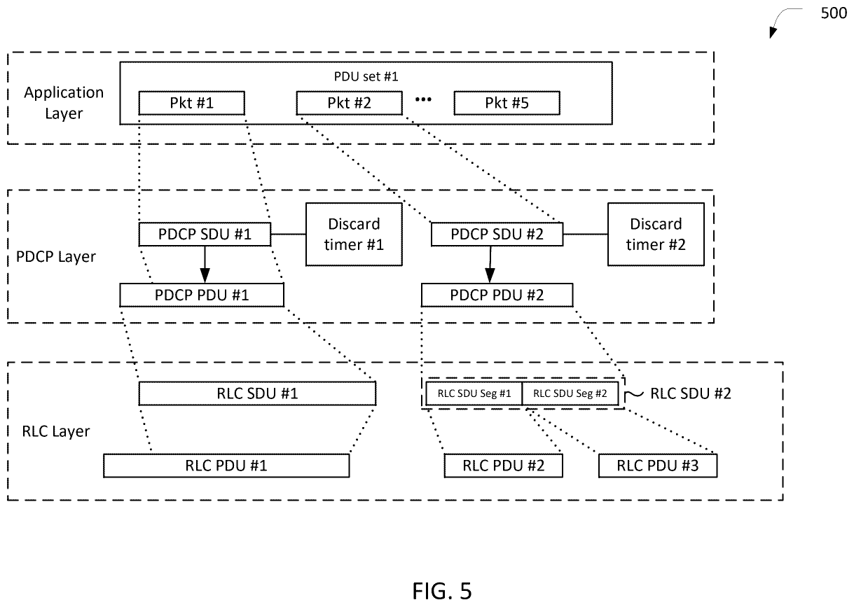

FIG. 5 illustrates data flow 500 in accordance with some embodiments. Data flow 500 is a logical example diagram of protocol layers and the data flow through various layers. Application layer, e.g., application layer 204 in FIG. 2, may generate PDU set #1, including packets #1-#5. Packet #1 of the PDU set #1 may be mapped to PDCP SDU #1. Upon receiving the PDCP SDU #1, the PDCP layer may configure and start a discard timer #1 and associate it with the PDCP SDU #1. Similarly, Packet #1 of the PDU set #1 may be mapped to PDCP SDU #2. Upon receiving the PDCP SDU #2, the PDCP layer may configure and start a discard timer #2 and assign it to the PDCP SDU #2.

PDCP layer may include PDCP SDU #1 in PDCP PDU #1. PDCP PDU #1 may also include a header and other information. Similarly, PDCP SDU #2 may be included in PDCP PDU #2 with other information.

At the RLC layer, PDCP PDU #1 and PDCP PDU #2 may be included in RLC SDU #1 and RLC SDU #2, respectively. The RLC SDU #1 may be included in the RLC PDU #1 along with the RLC header and other information. A segment of the RLC SDU #2, e.g., RLC SDU Seg #1, may be included in RLC PDU #2 along with the RLC header and other information, and the second segment of the RLC SDU #2, e.g., RLC SDU Seg #2 along with RLC header and other information may be included in RLC PDU #3.

There might be two ways that an RLC SDU may become delay-critical. In one example, the RLC SDU is delay-critical and is associated with a delay-critical PDCP PDU. A PDCP PDU may be delay-critical if it is associated with a delay-critical PDCP SDU. As described above, a PDCP SDU may become delay-critical when the remaining time of the associated discard timer is less than a threshold. For example, if PDCP SDU #2 becomes delay-critical, then PDCP PDU #2, RLC SDU Segment #1, RLC SDU Segment #2, RLC PDU #2, and RLC PDU #3 will become delay-critical as well.

In a second example, the RLC SDU or PDU may become delay-critical if it is associated with a PDU set where a packet of that PDU set is associated with a delay-critical PDCP SDU. For example, if PDCP SDU #1 becomes delay-critical, in the first example, only RLC SDU #1 and RLC PDU #1 would become delay-critical, and RLC SDU Segment #1, RLC SDU Segment #2, RLC PDU 2 and RLC PDU #3 would not become delay-critical. However, in the second example, when PDCP SDU #1 becomes delay-critical, it is associated with packet #1 of PDU set #1. Therefore, PDCP SDU #2 associated with packet #2 of the PDU set #1 would also become delay-critical. Consequently, PDCP PDU #2, RLC SDU Segment #1, RLC SDU Segment #2, RLC PDU #2, RLC PDU #3, PDCP PDU #1, RLC SDU #1, and RLC PDU #1 would become delay-critical.

Due to the nature of PDU sets, in some instances, when a packet becomes delay-critical, many other packets belonging to the same PDU set may also become delay-critical, e.g., when the PDU set discard is configured.

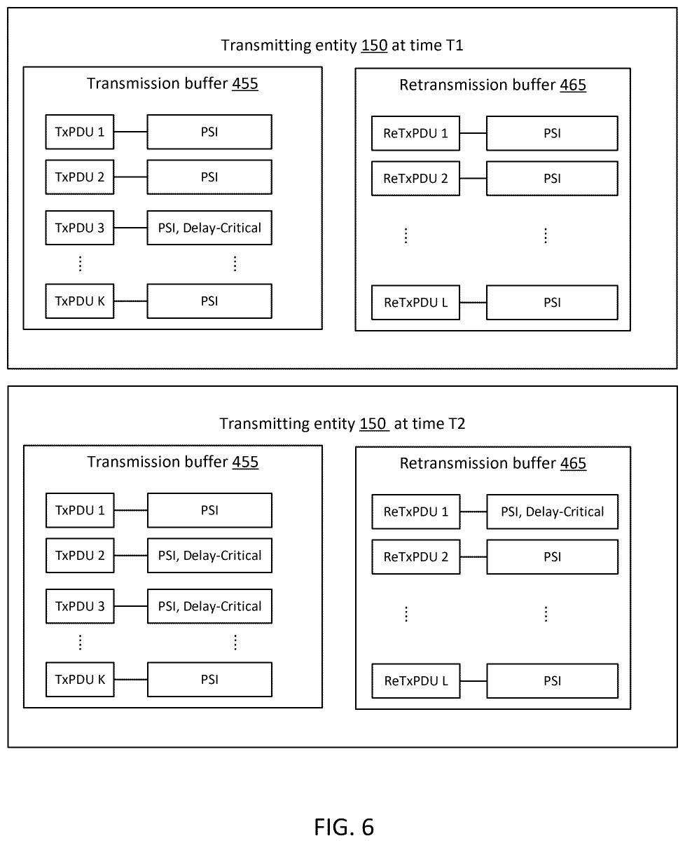

FIG. 6 illustrates aspects of an RLC transmitting entity 150 in accordance with some embodiments. RLC Transmitting entity 150 is illustrated at two different times, T1 and T2. Transmitting entity 150 includes a transmission buffer 455 and a retransmission buffer 465.

At time T1, transmission buffer 455 may store transmitting PDUs 1-K. Only transmitting PDU 3 may be delay-critical. Similarly, retransmission buffer 465 may store retransmitting PDUs 1-L. None of the retransmitting PDUs may be delay-critical. In some instances, information may be associated with each PDU in the transmission buffer 455 or retransmission buffer 465. Information may include a PSI field or a delay-critical indicator.

At time T2, transmitting PDU 2 and retransmitting PDU 1 may become delay-critical. For example, the discarding timer associated with the transmitting PDU 2 and retransmitting PDU 1 may become smaller than a threshold. The transmitting entity 150 at T2 may update information associated with transmitting PDU 2 and retransmitting PDU 1 accordingly to reflect that these PDUs are delay-critical.

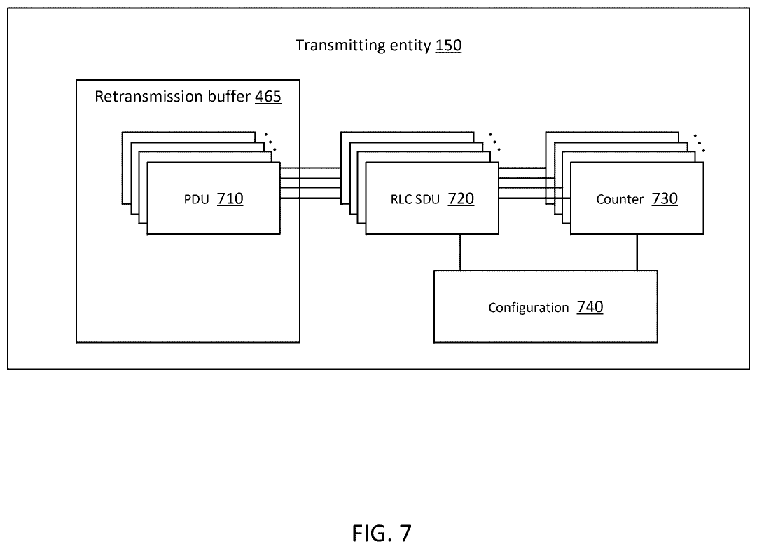

FIG. 7 illustrates aspects of transmitting entity 150 in accordance with some embodiments. The transmitting entity 150 may include a retransmission buffer 465. When an RLC SDU is received from the upper layer, e.g., PDCP, it is assigned a sequence number and may be segmented into RLC PDUs for transmission. In some instances, the entire SDU may be included in an RLC PDU. After the PDU is delivered to the lower layer for transmission, the PDU may be added, e.g., ReTxPDU 710, to the retransmission buffer, e.g., retransmission buffer 465. The transmitted PDU and the buffered PDU 710 are associated with an RLC SDU 720.

In some instances, the receiving entity 160 may send a positive acknowledgment indicating a successful reception of the PDU. For example, the receiving entity 160 may send the control PDU STATUS report, including Acks or Nacks associated with one or more PDUs. When a positive acknowledgment, e.g., Ack, is received, the corresponding PDU 710 is removed from the retransmission buffer. If the receiver does not acknowledge the PDU 710, indicating that it may have been lost or corrupted, or if the receiver negatively acknowledges, e.g., Nack, the PDU 710, the PDU 710 may remain in the retransmission buffer and may be considered for potential retransmissions.

The buffered PDU 710 may be associated with an RLC SDU 720. When the PDU 710 is retransmitted for the first time, a counter 730 may be configured and associated with the corresponding RLC SDU 720. The counter 730 may be a retransmission counter. In some instances, the counter 730 may be initialized with value 0 when the PDU 710 is retransmitted for the first time. With each subsequent retransmission, the counter is incremented. If an Ack associated with PDU 710 is received, the transmitting entity 150 may stop or reset the counter 730.

The network may configure the RLC entity, e.g., the transmitting entity 150, with configuration 740. Configuration 740 may be associated with the counter 730. For example, configuration 740 may include a parameter that determines the maximum number of retransmissions for RLC SDUs.

In some embodiments, configuration 740 may include one maximum number of retransmission thresholds for non-delay-critical RLC SDUs or SDU segments and another maximum number of retransmission threshold for delay-critical RLC SDU or SDU segments.

In some embodiments, configuration 740 may include one maximum number of retransmission thresholds for RLC SDUs or SDU segments corresponding to one or more packets associated with a first level of importance and another maximum number of retransmission threshold for RLC SDU or SDU segments corresponding to one or more packets associated with a second level of importance.

In some embodiments, configuration 740 may include one maximum number of retransmission thresholds for delay-critical RLC SDUs or SDU segments corresponding to one or more packets associating to a first level of importance and another maximum number of retransmission threshold for any other RLC SDU or SDU segments.

In some embodiments, the importance level may be based on the PSI level of the PDU set associated with the RLC SDU or SDU segments. For example, the retransmission counter 730 of the more important RLC SDU or SDU segments may be configured or associated with a maximum number of retransmission thresholds greater than that of a less important RLC SDU or SDU segments. In one example, a first RLC SDU or SDU segment is more important than a second RLC SDU when the PSI level of the first RLC SDU or SDU segment is smaller than that of the second RLC SDU or SDU segment.

In some embodiments, configuration 740 may include different thresholds associated with different PSI levels, where each threshold is a maximum number of retransmissions threshold.

In some embodiments, when an RLC SDU 720 (or an RLC SDU segment) is considered for retransmission, the transmitting entity 150 may determine if the RLC SDU 720 is a delay-critical RLC SDU. If the RLC SDU 720 is not delay-critical, configuration 740 may configure the counter 730 with the maximum number of retransmission threshold for non-delay-critical RLC SDUs or SDU segments. The transmitting entity 150 may perform retransmission of the RLC SDU 720 until a positive acknowledgment, e.g., Ack, is received or when the number of retransmissions associated with the counter 730 reaches the configured maximum number of retransmission threshold for non-delay-critical RLC SDUs.

In some other embodiments, when an RLC SDU 720 (or an RLC SDU segment) is considered for retransmission, the transmitting entity 150 may determine if the RLC SDU 720 corresponds to one or more packets associated with a first level of importance. If the RLC SDU 720 does not correspond to one or more packets associated with a first level of importance, configuration 740 may configure the counter 730 with the maximum number of retransmission threshold for RLC SDUs or SDU segments corresponding to one or more packets associating to a first level of importance. The transmitting entity 150 may perform retransmission of the RLC SDU 720 until a positive acknowledgment, e.g., Ack, is received or when the number of retransmissions associated with the counter 730 reaches the configured maximum number of retransmission threshold for RLC SDUs corresponding to one or more packets associating to a first level of importance.

In some embodiments, if the RLC SDU 720 is determined to be delay-critical, configuration 740 may configure the counter 730 with the maximum number of retransmission threshold for delay-critical RLC SDUs or SDU segments. The transmitting entity 150 may perform retransmission of the RLC SDU 720 until a positive acknowledgment, e.g., Ack, is received or when the number of retransmissions associated with the counter 730 reaches the configured maximum number of retransmission threshold for delay-critical RLC SDUs.

In some other embodiments, when an RLC SDU 720 (or an RLC SDU segment) is considered for retransmission, the transmitting entity 150 may determine if the RLC SDU 720 corresponds to one or more packets associated with a second level of importance. If the RLC SDU 720 does not correspond to one or more packets associated with the first level of importance, configuration 740 may configure the counter 730 with the maximum number of retransmission threshold for RLC SDUs or SDU segments corresponding to one or more packets associated with a second level of importance. The transmitting entity 150 may perform retransmission of the RLC SDU 720 until a positive acknowledgment, e.g., Ack, is received or when the number of retransmissions associated with the counter 730 reaches the configured maximum number of retransmission threshold for RLC SDUs corresponding to one or more packets associating to a second level of importance.

The maximum number of retransmissions for: non-delay-critical RLC SDUs, delay-critical RLC SDUs, RLC SDUs associated with a first level of importance, RLC SDUs associated with a second level of importance, delay-critical RLC SDUs, or each level of importance, as described in embodiments above, may be configured by radio resource control (RRC) configuration signaling. For example, the maximum number of retransmissions for non-delay-critical RLC SDUs may be the RRC field maxRetxThreshold. In another example, the maximum number of retransmissions for delay-critical RLC SDUs may be the new RRC field maxRetxThresholdDelayCritical. In some embodiments, the configured threshold for a maximum number of transmissions for non-delay-critical RLC SDUs may be greater than the value of the configured threshold for maximum retransmission for delay-critical RLC SDUs.

In some embodiments, the configured threshold for a maximum number of retransmissions for RLC SDUs corresponding to one or more packets associating with a first level of importance may be greater than the value of the configured threshold for maximum retransmission for RLC SDUs corresponding to one or more packets associating to a second level of importance.

The number of retransmissions of an RLC SDU 720 may be determined by the counter 740. In some instances, the number of retransmissions is the same as the value of the counter 730. In some instances, the number of retransmissions may be the value of the counter 740 plus one.

When the number of retransmissions of a delay-critical RLC SDU 720 (or its segments) reaches the configured threshold for the maximum number of retransmissions for delay-critical RLC SDUs, or when the number of retransmissions of an RLC SDU (or its segments) corresponding to one or more packets associated with a first level of importance reaches the configured threshold for the maximum number of retransmissions for RLC SDUs corresponding to one or more packets associating to a first level of importance, the transmitting entity 150 may no longer consider the RLC SDU 720 (or its segments) for retransmission. The transmitting entity 150 may follow one or more of the following operations. In some embodiments, the transmitting entity 150 may consider the RLC SDU 720 positively acknowledged. In some embodiments, the transmitting entity 150 may consider the RLC SDU 720 negatively acknowledged. In some embodiments, the transmitting entity 150 may stop considering the RLC SDU 720 for further retransmissions. In some embodiments, the transmitting entity 150 may indicate to the upper layer that the number of retransmissions of the RLC SDU 720 has reached the configured threshold for the maximum number of transmissions for delay-critical RLC SDUs. The indication may trigger actions in the upper layer, such as the initialization of the radio link failure (RLF) procedure. In some embodiments, the transmitting entity 150 may indicate to the lower layer that the number of retransmissions of the RLC SDU 720 has reached the configured threshold for the maximum number of transmissions for delay-critical RLC SDUs. The indication may trigger actions in the lower layer, such as sending Layer 1 (L1) or Layer 2 (L2) signaling, including scheduling request (SR), buffer status report (BSR), or delay state report (DSR). In some embodiments, the transmitting entity 150 may send a control message, e.g., an RLC control PDU to the receiving entity 160 to notify that the number of retransmissions of the RLC SDU 720 has reached the configured threshold for the maximum number of transmissions for delay-critical RLC SDUs. In some embodiments, the transmitting entity 150 may trigger a poll, e.g., include a poll in the next AMD PDU.

In some embodiments, when the number of retransmissions of the RLC SDU 720 (or its segments) has reached the configured threshold for the maximum number of transmissions for delay-critical RLC SDUs, or when the number of retransmissions of an RLC SDU (or its segments) corresponding to one or more packets associated with a first level of importance reaches the respective configured threshold for the maximum number of retransmissions for RLC SDUs corresponding to one or more packets associating to a first level of importance, the transmitting entity 150, through interaction with the upper layer, may evaluate the remaining time until discarding of the PDCP SDU associated with the RLC SDU 720. Additionally or alternatively, through interaction with the lower layer, transmitting entity 150 may evaluate any available radio resources for RLC SDU 720. Based on these evaluations, the transmitting entity 150 may determine whether to continue with further retransmissions of the RLC SDU 720, although the number of retransmissions of the RLC SDU 720 has reached the configured threshold for the maximum number of transmissions for delay-critical RLC SDUs.

The network may configure the threshold for the maximum number of retransmissions for delay-critical RLC SDUs. It is unlikely that a delay-critical RLC SDU 720 will have remaining time available after the number of retransmissions reaches the threshold.

As described in FIG. 6, in some embodiments, the RLC SDU 720 is delay-critical before its initial transmission. In other embodiments, the RLC SDU 720 may become delay-critical after its initial transmission, e.g., during the automatic repeat request (ARQ) procedure.

In some embodiments, the transmitting entity 150 may stop considering the delay-critical RLC SDU 720 or RLC SDU corresponding to one or more packets associated with a first level of importance for retransmission before its number of retransmissions reaches the configured threshold for the maximum number of transmissions for delay-critical RLC SDUs or RLC SDU corresponding to one or more packets associating to a first level of importance. For example, when a discarding notification is received from the higher layer indicating that the PDCP SDU or PDU set associated with the delay-critical RLC SDU 720 (or its segments) were discarded, the transmitting entity 150 may stop considering the delay-critical RLC SD 720 for retransmission.

In another example, when a discarding notification is received from the higher layer indicating that the PDCP SDU or PDU set associated with the first level of importance was discarded, the transmitting entity 150 may stop considering the RLC SDU corresponding to one or more packets associating to a first level of importance for retransmission.

In some embodiments, when an RLC SDU 720 or an RLC SDU segment is considered for retransmission, the transmitting side of the AM RLC entity may: if the RLC SDU or RLC SDU segment is considered for retransmission for the first time: set the RETX_COUNT associated with the RLC SDU to zero. Else, if it (the RLC SDU 720 or the RLC SDU segment that is considered for retransmission) is not pending for retransmission already and the RETX_COUNT associated with the RLC SDU 720 has not been incremented due to another negative acknowledgment in the same STATUS PDU: then increment the RETX_COUNT. If the RLC SDU 720 or RLC SDU segment corresponds to a delay-critical RLC SDU: if RETX_COUNT=maxRetxThresholdDelayCritical: consider the RLC SDU 720 or RLC SDU segment as positively acknowledged. Else, if RETX_COUNT=maxRetxThreshold: indicate to upper layers that max retransmission has been reached.

In some embodiments, when an RLC SDU 720 or an RLC SDU segment is considered for retransmission, the transmitting side of the AM RLC entity may: if the RLC SDU 720 or RLC SDU segment is considered for retransmission for the first time: set the RETX_COUNT associated with the RLC SDU to zero. Else, if it (the RLC SDU or the RLC SDU segment that is considered for retransmission) is not pending for retransmission already and the RETX_COUNT associated with the RLC SDU 720 has not been incremented due to another negative acknowledgment in the same STATUS PDU: increment the RETX_COUNT. If the RLC SDU or RLC SDU segment corresponds to a Delay-Critical RLC SDU: if RETX_COUNT=min (maxRetxThreshold, maxRetxThresholdDelayCritical): consider the RLC SDU 720 or RLC SDU segment as positively acknowledged. Else, if RETX_COUNT=maxRetxThreshold: indicate to upper layers that max retransmission has been reached.

In some embodiments, whether configuration 740 applies the threshold for the maximum number of transmissions for delay-critical RLC SDUs or RLC SDUs corresponding to one or more packets associated with a first level of importance to the RLC SDU 720 may depend on one or more conditions. One or more conditions may include: whether congestion is detected on the data radio bearer (DRB) associated with the delay-critical RLC SDU 720; whether PSI-based or importance-based packet discarding is activated on the corresponding DRB; whether the delay-critical RLC SDU 720 (or its segments) correspond to an important packet, e.g., an important PDU set; whether the buffered data volume or delay-critical data volume exceeds a threshold; whether the RLC transmitting window is stalled, e.g., new transmission cannot be performed; or whether the sequence number (SN) gap between two acknowledged RLC SDUs exceed a threshold.

In some embodiments, the transmitting side of RLC AM, e.g., the transmitting entity 150, may determine or select the maximum retransmission threshold value for the RLC SDU 720 based on the remaining time until discarding associated with the RLC SDU 720. For example, the remaining time until discarding may be quantized into bins and groups, and a maximum retransmission threshold may be assigned for each bin or group. The transmitting entity 150 may determine the remaining time until the discarding of RLC SDU 720, quantize it, determine to which group or bin it belongs, and determine the maximum retransmission threshold based on the threshold assigned to the corresponding quantization bin.

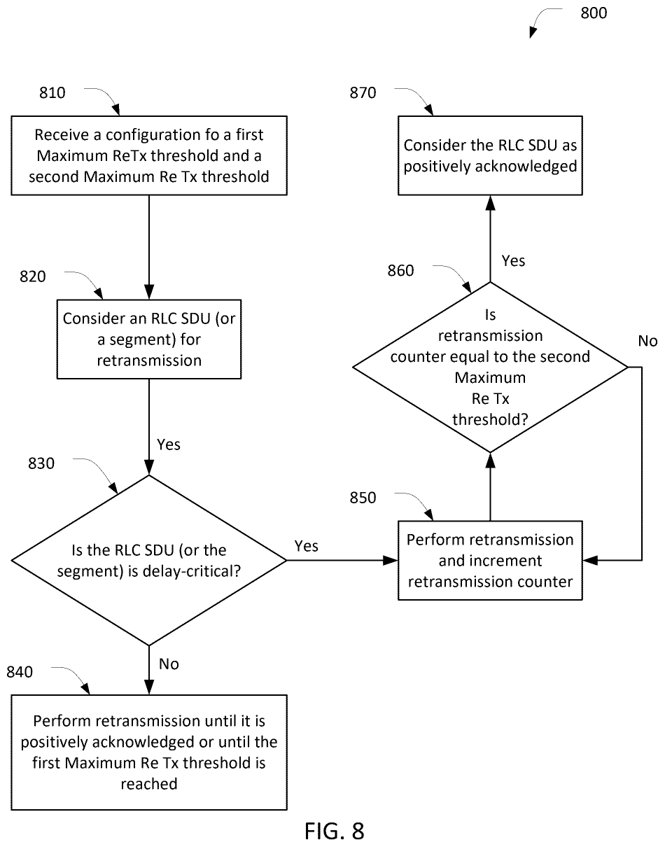

FIG. 8 illustrates another operation flow/algorithmic structure 800 in accordance with some embodiments. The algorithmic structure 800 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or network device 1400, or components thereof, for example, baseband processor circuitry 1404A.

The operation flow/algorithmic structure 800 may include, at 810, receiving a configuration of a first maximum retransmission threshold and a second maximum retransmission threshold. The first maximum retransmission threshold may be associated with non-delay-critical RLC SDUs, and the second maximum retransmission threshold may be associated with the delay-critical RLC SDUs.

The operation flow/algorithmic structure 800 may include, at 820, considering an RLC SDU (or its segment) for retransmission. For example, a negative acknowledgment associated with the RLC SDU is received.

The operation flow/algorithmic structure 800 may include, at 830, determining whether the RLC SDU (or its segments) is delay-critical. In one example, the RLC SDU may be delay-critical if the discarding timer of the PDCP SDU associated with the RLC SDU is less than a threshold. If the RLC SDU is delay-critical, the process 800 may proceed to 850. Otherwise, the process 800 may proceed to 840.

The operation flow/algorithmic structure 800 may include, at 840, performing retransmission until the RLC SDU (or its segments) is positively acknowledged or until the number of retransmissions reaches the first maximum number of retransmission threshold.

The operation flow/algorithmic structure 800 may include, at 850, performing retransmission and updating the retransmission counter, e.g., by incrementing it.

The operation flow/algorithmic structure 800 may include, at 860, determining whether the number of retransmissions, based on the value of the retransmission counter, has reached the second maximum number of retransmission threshold. For example, the transmission counter, e.g., its value, may be the same as the number of retransmissions of the RLC SDU. If the number of retransmissions has reached the second maximum retransmission threshold, the process 800 may proceed to 870. Otherwise, process 800 may proceed to 850.

The operation flow/algorithmic structure 800 may include, at 870, considering the RLC SDU as positively acknowledged. In other embodiments, the transmitting entity 150 may no longer consider the RLC SDU for retransmission and perform one or more of the operations described above.

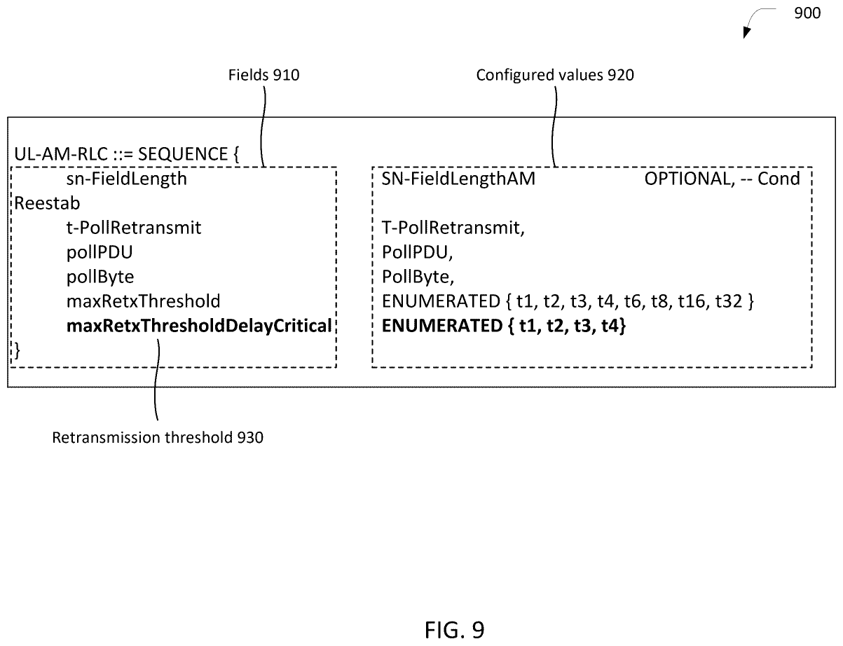

FIG. 9 illustrates retransmission configuration 900 in accordance with some embodiments. The retransmission configuration 900 is an example of an RRC configuration associated with the AM RLC. The retransmission configuration 900 may be part of the RLC configuration.

In some embodiments, the retransmission configuration 900 may include fields 910 and configured values 920. Respective to each field in fields 910, there is a value in configured values 920. For example, fields 910 may include a parameter t-PollRetransmit that is configured with the value of T-PollRetransmit in configured values 920.

The retransmission configuration 900 may include the parameter maxRetxThreshold, which is the threshold for the maximum number of retransmissions for non-delay-critical RLC SDUs. It may take one of the values t1, t2, t3, t4, t6, t8, t16, or t32, e.g., when configured, one of the enumerated values may be assigned to this parameter.

The retransmission configuration 900 may include the parameter maxRetxThresholdDelayCritical 930, which is the threshold for the maximum number of retransmissions for delay-critical RLC SDUs. It may take one of the values t1, t2, t3, or t4, e.g., when configured, one of the enumerated values may be assigned to this parameter.

In some embodiments, the maxRetxThresholdDelayCritical 930 may be described as a parameter for RLC AM in TS 38.322. Value t1 corresponds to 1 retransmission, value t2 corresponds to 2 retransmission, and so on. The value of this field is always smaller than maxRetxThreshold.

In some embodiments, the maxRetxThresholdDelayCritical 930 may be configured by configuring an offset value with respect to maxRetxThreshold. In that case, the field may be named as maxRetxThresholdOffset. For example, maxRetxThresholdDelayCritical 930 may be obtained or calculated by adding (or subtracting) the maxRetxThresholdOffset to (from) maxRetxThreshold.

In some embodiments, the maxRetxThresholdDelayCritical 930 may be configured by configuring a fraction value of maxRetxThreshold. In that case, the field may be named as maxRetxThresholdFraction. For example, maxRetxThresholdDelayCritical 930 may be obtained or calculated by multiplying (or dividing) maxRetxThreshold with (by) maxRetxThresholdFraction.

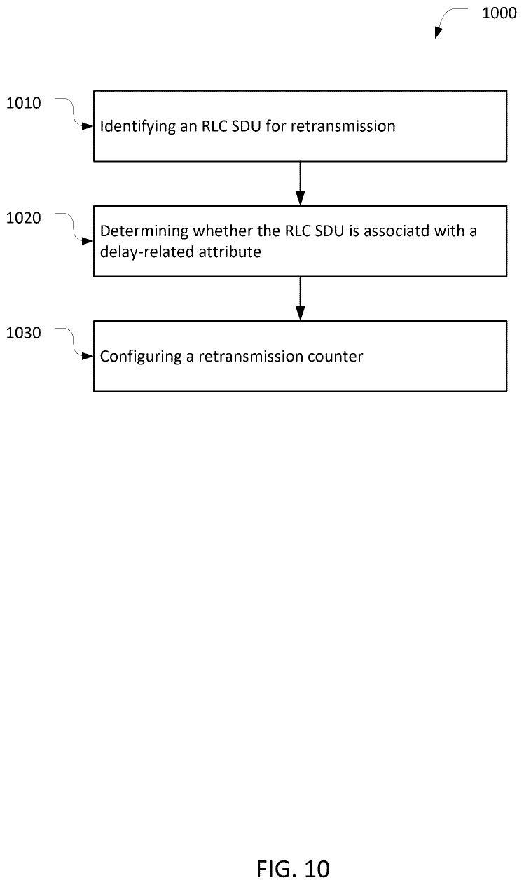

FIG. 10 illustrates another operation flow/algorithmic structure in accordance with some embodiments. The algorithmic structure 1000 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or network device 1400, or components thereof, for example, baseband processor circuitry 1404A.

The operation flow/algorithmic structure 1000 may include, at 1010, identifying an RLC SDU for retransmission. The RLC SDU may be associated with an RLC PDU in the retransmission buffer of the transmitting entity 150.

The operation flow/algorithmic structure 1000 may include, at 1020, determining whether the RLC SDU is associated with a delay-related attribute. The delay-related attribute may be being delay-critical. The transmitting entity 150 may determine that the RLC SDU for retransmission is a delay-critical RLC SDU. The transmitting entity 150 may determine that the RLC SDU for retransmission is not a delay-critical RLC SDU. The transmitting entity 150 may determine whether the RLC SDU is delay-critical based on a discarding timer of a PDCP SDU associated with the RLC SDU or a PDU Set associated with the RLC SDU.

The operation flow/algorithmic structure 1000 may include, at 1030, configuring a retransmission counter. The transmitting entity 150 may receive a configuration from the network associated with the maximum number of retransmission thresholds. The configuration may have two different values of the maximum number of retransmission thresholds, one associated with non-delay-critical RLC SDUs and one associated with the delay-critical RLC SDUs. The transmitting entity 150 may select one of these thresholds to configure the retransmission counter based on the determination of whether the RLC SDU for retransmission is delay-critical or not. If the RLC SDU is delay-critical, the transmitting entity may select the maximum number of retransmission thresholds associated with the delay-critical RLC SDUs to configure the retransmission counter. If the RLC SDU is not delay-critical, the transmitting entity 150 may select the maximum number of retransmission thresholds associated with the non-delay-critical RL SDUs to configure the retransmission counter.

In some embodiments, the RLC entity may receive and process a configuration including one or more parameters to obtain a first threshold and a second threshold, where the first threshold is associated with the maximum number of retransmission threshold of non-delay-critical RLC SDUs and the second threshold is associated with the maximum number of retransmission threshold of delay-critical RLC SDUs. In one embodiment, the configuration includes the first threshold and an offset value. In another embodiment, the configuration includes the first threshold and a fraction value.

In some embodiments, the RLC SDU is a delay-critical RLC SDU, and the transmitting entity 150 may determine that a positive acknowledgment associated with the RLC SDU is not received. The transmitting entity 150 may identify the number of retransmissions of the RLC SDU based on the retransmission counter and determine that the number of retransmissions of the RLC SDU has reached the maximum number of retransmission threshold for the delay-critical RLC SDUs. The transmitting entity may perform one or more of the following operations: considering the RLC SDU is positively acknowledged; removing the RLC SDU from being considered for retransmission; generating a first message to be transmitted to an upper layer, the first message to indicate that the number of retransmissions of the RLC SDU reached the maximum retransmission threshold and that a positive acknowledgment associated with the RLC SDU was not received; generating a second message to be transmitted to a lower layer, the second message to indicate that the number of retransmissions of the RLC SDU reached the maximum retransmission threshold and that a positive acknowledgment associated with the RLC SDU was not received; generating a third message to be transmitted to a peer RLC receiving entity, the third message to indicate that the number of retransmissions of the RLC SDU reached the maximum retransmission threshold and that a positive acknowledgment associated with the RLC SDU was not received; triggering a poll by setting a polling flag in a protocol data unit (PDU); or considering that the RLC SDU is negatively acknowledged.

In some embodiments, the RLC SDU is a delay-critical RLC SDU, and the transmitting entity 150 may determine that a positive acknowledgment associated with the RLC SDU is not received. The transmitting entity 150 may identify the number of retransmissions of the RLC SDU based on the retransmission counter and determine that the number of retransmissions of the RLC SDU has reached the maximum number of retransmission threshold for the delay-critical RLC SDUs. The transmitting entity may perform one or more of the following operations: identifying a remaining time until discarding associated with the RLC SDU; identifying a remaining radio resource available to the RLC SDU; and determining whether to continue with one or more additional retransmissions.

In some embodiments, the transmitting entity 150 may apply the maximum number of retransmissions threshold for delay-critical RLC SDUs based on detecting one or more conditions. One or more conditions may include detecting whether: congestion is detected on a data radio bearer (DRB) associated with the RLC SDU; an importance-based packet discarding is activated on the DRB associated with the RLC SDU; the RLC SDU is associated with an important protocol data unit (PDU) set; a buffered data volume exceeds a first threshold; a buffered data volume of one or more RLC SDUs associated with a delay-related attribute exceeds a second threshold; a transmitting window of a transmitting entity is stalled; or a sequence number gap between two acknowledged RLC SDUs exceeds a third threshold.

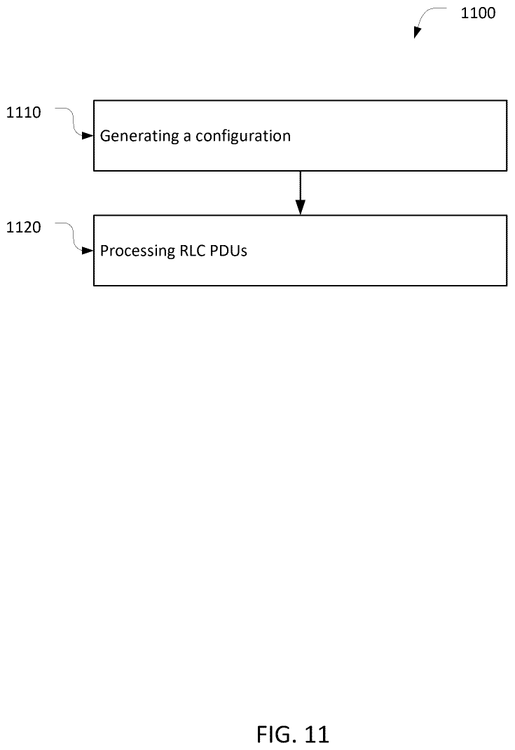

FIG. 11 illustrates another operation flow/algorithmic structure in accordance with some embodiments. The operation flow/algorithmic structure 1100 may be performed or implemented by a network device such as, for example, the base station 108 or the network device 1400; or components thereof, for example, baseband processor circuitry 1404A.

The operation flow/algorithmic structure 1100 may include, at 1110, generating a configuration. The configuration may be transmitted to a UE for configuration. The configuration may include one or more parameters associated with a first threshold and a second threshold, where the first and second thresholds are associated with a maximum retransmission threshold of a retransmission counter, and the retransmission counter may be associated with a radio link control (RLC) entity of the network node.

In some embodiments, the configuration may include one or more parameters to obtain a first threshold and a second threshold. In one example, the first threshold is associated with the maximum number of retransmission threshold of non-delay-critical RLC SDUs, and the second threshold is associated with the maximum number of retransmissions threshold of delay-critical RLC SDUs. In another example, the first threshold is associated with the maximum number of retransmissions threshold associated with the first importance level, and the second threshold is associated with the maximum number of retransmissions threshold associated with the second importance level. In one embodiment, the configuration may include the first threshold and an offset value. In another embodiment, the configuration may include the first threshold and a fraction value.

The operation flow/algorithmic structure 1100 may include, at 1110, processing RLC PDUs. The RLC PDUs may be received from an RLC entity of a UE and consistent with the configuration of the maximum number of retransmission thresholds for non-delay-critical and delay-critical RLC SDUs.

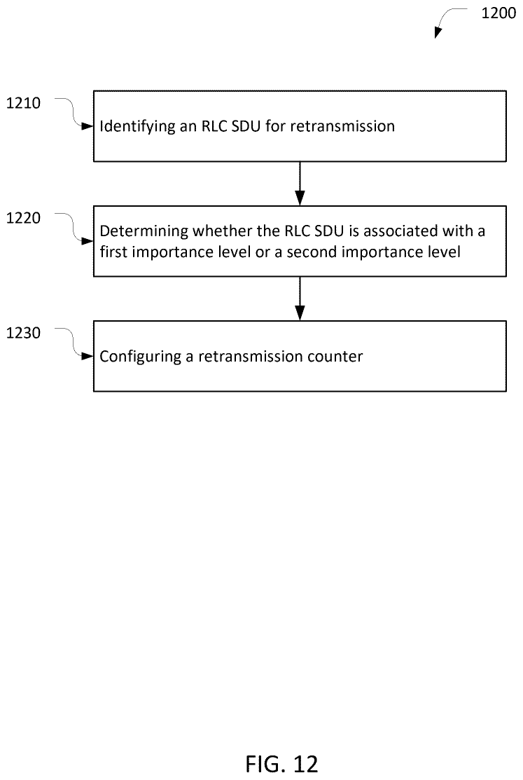

FIG. 12 illustrates another operation flow/algorithmic structure in accordance with some embodiments. The algorithmic structure 1200 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or network device 1400, or components thereof, for example, baseband processor circuitry 1404A.

The operation flow/algorithmic structure 1200 may include, at 1210, identifying an RLC SDU for retransmission. The RLC SDU may be associated with an RLC PDU in the retransmission buffer of the transmitting entity 150.

The operation flow/algorithmic structure 1200 may include, at 1220, determining whether the RLC SDU is associated with a first importance level or a second importance level. The importance level may be the PSI level of the PDU Set associated with the RLC SDU. In addition, the transmitting entity 150 may determine that the RLC SDU for retransmission is a delay-critical RLC SDU. The transmitting entity 150 may determine that the RLC SDU for retransmission is not a delay-critical RLC SDU. The transmitting entity 150 may determine whether the RLC SDU is delay-critical based on a discarding timer of a PDCP SDU associated with the RLC SDU or a PDU Set associated with the RLC SDU.

The operation flow/algorithmic structure 1200 may include, at 1230, configuring a retransmission counter. The transmitting entity 150 may receive a configuration from the network associated with the maximum number of retransmission thresholds. The configuration may have two different values of the maximum number of retransmission thresholds; one value may be associated with RLC SDUs that are associated with the first importance level, and another value may be associated with the RLC SDUs that are associated with the second importance level. The transmitting entity 150 may select one of these thresholds to configure the retransmission counter based on the determination of the importance level associated with the RLC SDU for retransmission.

In some embodiments, the RLC entity may receive and process a configuration including one or more parameters to obtain a first threshold and a second threshold, where the first threshold is associated with the maximum number of retransmission threshold of RLC SDUs associated with the first importance level and the second threshold is associated with the maximum number of retransmission threshold of RLC SDUs associated with the second importance level. In one embodiment, the configuration includes the first threshold and an offset value. In another embodiment, the configuration includes the first threshold and a fraction value.

In some embodiments, the transmitting entity 150 may determine that a positive acknowledgment associated with the RLC SDU is not received. The transmitting entity 150 may identify the number of retransmissions of the RLC SDU based on the retransmission counter and determine that the number of retransmissions of the RLC SDU has reached the maximum number of retransmission threshold for the RLC SDUs. The transmitting entity may perform one or more of the following operations: considering the RLC SDU is positively acknowledged; removing the RLC SDU from being considered for retransmission; generating a first message to be transmitted to an upper layer, the first message to indicate that the number of retransmissions of the RLC SDU reached the maximum retransmission threshold and that a positive acknowledgment associated with the RLC SDU was not received; generating a second message to be transmitted to a lower layer, the second message to indicate that the number of retransmissions of the RLC SDU reached the maximum retransmission threshold and that a positive acknowledgment associated with the RLC SDU was not received; generating a third message to be transmitted to a peer RLC receiving entity, the third message to indicate that the number of retransmissions of the RLC SDU reached the maximum retransmission threshold and that a positive acknowledgment associated with the RLC SDU was not received; triggering a poll by setting a polling flag in a protocol data unit (PDU); or considering that the RLC SDU is negatively acknowledged.

In some embodiments, the transmitting entity 150 may apply the maximum number of retransmissions threshold based on the importance level of the RLC SDUs based on detecting one or more conditions. One or more conditions may include detecting whether: congestion is detected on a data radio bearer (DRB) associated with the RLC SDU; an importance-based packet discarding is activated on the DRB associated with the RLC SDU; the RLC SDU is associated with an important protocol data unit (PDU) set; a buffered data volume exceeds a first threshold; a buffered data volume of one or more RLC SDUs associated with a delay-related attribute exceeds a second threshold; a transmitting window of a transmitting entity is stalled; or a sequence number gap between two acknowledged RLC SDUs exceeds a third threshold.

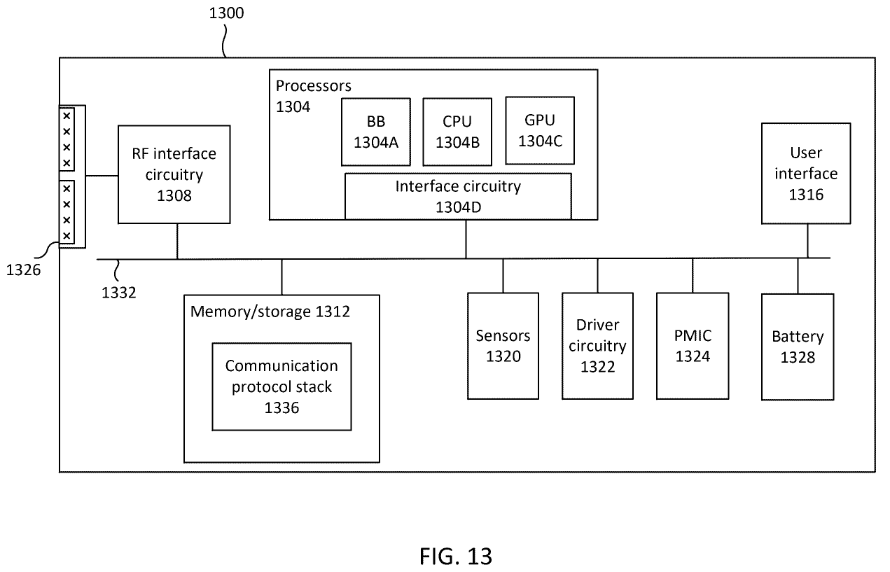

FIG. 13 illustrates a UE 1300 in accordance with some embodiments. The UE 1300 may be similar to and substantially interchangeable with the UE 104.

The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1300 may include processors 1304, RF interface circuitry 1308, memory/storage 1312, user interface 1316, sensors 1320, driver circuitry 1322, power management integrated circuit (PMIC) 1324, antenna 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1332, which may represent any type of interface, input/output, bus (local, system, or expansion), transmission line, trace, or optical connection that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry, or processor circuitry that executes or otherwise operates computer-executable instructions, such as program code, software modules, or functional processes from memory/storage 1312 to cause the UE 1300 to perform operations as described herein. The processors 1304 may also include interface circuitry 1304D to communicatively couple the processor circuitry with one or more other components of the UE 1300.

In some embodiments, the baseband processor circuitry 1304A may access a communication protocol stack 1336 in the memory/storage 1312 to communicate over a 3GPP-compatible network. In general, the baseband processor circuitry 1304A may access the communication protocol stack 1336 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the UE 1300 to perform various operations described herein.

The memory/storage 1312 includes any type of volatile or non-volatile memory that may be distributed throughout the UE 1300. In some embodiments, some of the memory/storage 1312 may be located on the processors 1304 themselves (for example, memory/storage 1312 may be part of a chipset that corresponds to the baseband processor circuitry 1304A), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, or phased array antennas. The antenna 1326 may have one or more panels designed for specific frequency bands including bands in FR1 or FR2.

The user interface 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1300.

The sensors 1320 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within or connected to the UE 1300. For example, driver circuitry 1322 may include a display driver to control and allow access to a display device, a touchscreen driver to control and allow access to a touchscreen interface, sensor drivers to obtain sensor readings of sensors 1320, and control and allow access to sensors 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

A battery 1328 may power the UE 1300, although in some examples, the UE 1300 may be mounted deployed in a fixed location and may have a power supply coupled to an electrical grid. The battery 1328 may be a lithium-ion battery, a metal-air battery, such as a zinc-air battery, an aluminum-air battery, a lithium-air battery, and the like. In some implementations, such as in vehicle-based applications, the battery 1328 may be a typical lead-acid automotive battery.

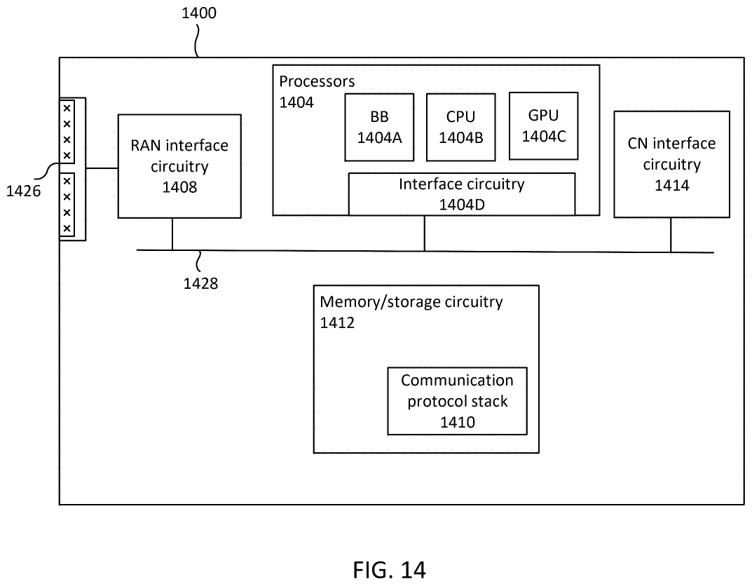

FIG. 14 illustrates a network device 1400 in accordance with some embodiments. The network device 1400 may be similar to and substantially interchangeable with base station 108.

The network device 1400 may include processors 1404, RF interface circuitry 1408 (if implemented as a base station), core network (CN) interface circuitry 1414, memory/storage circuitry 1412, and antenna structure 1426.

The components of the network device 1400 may be coupled with various other components over one or more interconnects 1428.

The processors 1404, RF interface circuitry 1408, memory/storage circuitry 1412 (including communication protocol stack 1410), antenna structure 1426, and interconnects 1428 may be similar to like-named elements shown and described with respect to FIG. 13.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage circuitry 1412 to cause the UE 1300 to perform operations as described herein. The processors 1404 may also include interface circuitry 1404D to communicatively couple the processor circuitry with one or more other components of the network device 1400.

The CN interface circuitry 1414 may provide connectivity to a core network, for example, a 5th Generation Core network (5GC) using a 5GC-compatible network interface protocol such as carrier Ethernet protocols or some other suitable protocol. Network connectivity may be provided to/from the network device 1400 via a fiber optic or wireless backhaul. The CN interface circuitry 1414 may include one or more dedicated processors or FPGAs to communicate using one or more of the aforementioned protocols. In some implementations, the CN interface circuitry 1414 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### Examples

In the following sections, further exemplary embodiments are provided.

Example 1 includes a method including: identifying a radio link control (RLC) service data unit (SDU) for retransmission; determining whether the RLC SDU is associated with a delay-related attribute; and configuring a retransmission counter associated with the RLC SDU based on said determining whether the RLC SDU is associated with the delay-related attribute.

Example 2 includes the method of example 1 or some other examples herein, wherein the delay-related attribute is being delay-critical.

Example 3 includes the method of examples 1 or 2 or some other example herein, further including: processing a configuration including one or more parameters to obtain a first threshold and a second threshold, the first and second thresholds associated with a maximum retransmission threshold of the retransmission counter.

Example 4 includes the method of any of examples 1-3 or some other example herein, wherein the first threshold is associated with a non-delay-related configuration, the second threshold is associated with a delay-related configuration, and the second threshold is smaller than the first threshold.

Example 5 includes the method of any of examples 1˜4 or some other example herein, wherein the configuration is included in a radio resource control (RRC) configuration signaling.

Example 6 includes the method of any of examples 1-5 or some other example herein, wherein the one or more parameters include the first threshold and an offset value, and the method further includes: obtaining the second threshold based on the first threshold and the offset value.

Example 7 includes the method of any of examples 1-6 or some other example herein, wherein the one or more parameters include the first threshold and a fraction value, and the method further includes: obtaining the second threshold based on the first threshold and the fraction value.

Example 8 includes the method of any of examples 1-7 or some other example herein, wherein: said determining whether the RLC SDU is associated with a delay-related attribute includes: determining that the RLC SDU is not associated with the delay-related attribute; and said configuring the retransmission counter associated with the RLC SDU includes: configuring the maximum retransmission threshold of the retransmission counter associated with the RLC SDU with the first threshold.

Example 9 includes the method of any of examples 1-8 or some other example herein, wherein: said determining whether the RLC SDU is associated with a delay-related attribute includes: determining that the RLC SDU is associated with the delay-related attribute; and said configuring the retransmission counter associated with the RLC SDU includes: identifying a remaining time until discarding associated with the RLC SDU; selecting or determining a third threshold based on the remaining time until discarding associated with the RLC SDU; and configuring the maximum retransmission threshold of the retransmission counter associated with the RLC SDU with the third threshold.

Example 10 includes the method of any of examples 1-9 or some other example herein, wherein: said determining whether the RLC SDU is associated with a delay-related attribute includes: determining that the RLC SDU is associated with the delay-related attribute; and said configuring the retransmission counter associated with the RLC SDU includes: configuring the maximum retransmission threshold of the retransmission counter associated with the RLC SDU with the second threshold.

Example 11 includes the method of any of examples 1-10 or some other example herein, further including: identifying a number of retransmissions of the RLC SDU associated with the retransmission counter; determining that the number of retransmissions of the RLC SDU is less than the maximum retransmission threshold; processing a discard notification associated with the RLC SDU, the discard notification received from a higher layer; and removing the RLC SDU from being considered for retransmission based on the notification.

Example 12 includes the method of any of examples 1-11 or some other example herein, further including: determining that a positive acknowledgment associated with the RLC SDU is not received; identifying a number of retransmissions of the RLC SDU associated with the retransmission counter; determining that the number of retransmissions of the RLC SDU is less than the maximum retransmission threshold; and retransmitting the RLC SDU based on the said determining that a positive acknowledgment associated with the RLC SDU is not received and said determination that the number of retransmissions of the RLC SDU is less than the maximum retransmission threshold.

Example 13 includes the method of any of examples 1-12 or some other example herein, further including: identifying a number of retransmissions of the RLC SDU associated with the retransmission counter; determining that the number of retransmissions of the RLC SDU is equal to the maximum retransmission threshold; and performing an operation based on said determining that the number of retransmissions of the RLC SDU is equal to the maximum retransmission threshold.

Example 14 includes the method of any of examples 1-13 or some other example herein, wherein said performing the operation includes: considering the RLC SDU is positively acknowledged; removing the RLC SDU from being considered for retransmission; generating a first message to be transmitted to an upper layer, the first message to indicate that the number of retransmissions of the RLC SDU reached the maximum retransmission threshold and that a positive acknowledgment associated with the RLC SDU was not received; generating a second message to be transmitted to a lower layer, the second message to indicate that the number of retransmissions of the RLC SDU reached the maximum retransmission threshold and that a positive acknowledgment associated with the RLC SDU was not received; generating a third message to be transmitted to a peer RLC receiving entity, the third message to indicate that the number of retransmissions of the RLC SDU reached the maximum retransmission threshold and that a positive acknowledgment associated with the RLC SDU was not received; triggering a poll by setting a polling flag in a protocol data unit (PDU); or considering that the RLC SDU is negatively acknowledged.

Example 15 includes the method of any of examples 1-14 or some other example herein, wherein said performing the operation includes; identifying a remaining time until discarding associated with the RLC SDU; identifying a remaining radio resource available to the RLC SDU; and determining whether to continue with one or more additional retransmissions.

Example 16 includes the method of any of examples 1-15 or some other example herein, further including: detecting a condition, wherein said performing the operation is based further on said detecting the condition.

Example 17 includes the method of any of examples 1-16 or some other example herein, wherein detecting the condition includes detecting whether: congestion is detected on a data radio bearer (DRB) associated with the RLC SDU; an importance-based packet discarding is activated on the DRB associated with the RLC SDU; the RLC SDU is associated with an important protocol data unit (PDU) set; a buffered data volume exceeds a first threshold; a buffered data volume of one or more RLC SDUs associated with a delay-related attribute exceeds a second threshold; a transmitting window of a transmitting entity is stalled; or a sequence number gap between two acknowledged RLC SDUs exceeds a third threshold.

Example 18 includes a method including: generating a configuration to be transmitted and configure a user equipment (UE), the configuration including one or more parameters associated with a first threshold and a second threshold, the first and second thresholds associated with a maximum retransmission threshold of a retransmission counter, the retransmission counter associated with a radio link control (RLC) entity of the UE; and processing RLC protocol data units (PDUs) received from the UE and consistent with the configuration; and memory interface circuitry coupled with the processing circuitry to store the configuration in memory.

Example 19 includes the method of example 18 or some other example herein, wherein the first threshold is associated with non-delay-critical RLC SDUs and the second threshold is associated with delay-critical RLC SDUs.

Example 20 includes the method of examples 18 or 19 or some other example herein, wherein the configuration includes the first threshold and an offset value.

Example 21 includes the method of any of examples 18-20 or some other example herein, wherein the configuration includes the first threshold and a fraction value.

Example 22 includes the method of any of examples 18-21 or some other example herein, wherein the configuration is an information element of an RLC configuration in radio resource control (RRC) configurations.

Example 23 includes a method including: identifying a radio link control (RLC) service data unit (SDU) for retransmission; determining whether the RLC SDU is associated with a first importance level or a second importance level; and configuring a retransmission counter associated with the RLC SDU based on said determining whether the RLC SDU is associated with the first importance level or the second importance level.

Example 24 includes the method of example 23 or some other example herein, wherein an importance level is a protocol data unit (PDU) set importance (PSI) level, the first importance level is a first PSI level, and the second importance level is a second PSI level.

Example 25 includes the method of examples 23 or 24 or some other example herein, further including: processing a configuration including one or more parameters to obtain a first threshold and a second threshold, the first and second thresholds associated with a maximum retransmission threshold of the retransmission counter.

Example 26 includes the method of any of examples 23-25 or some other example herein, wherein the first threshold is associated with a non-delay-related configuration, the second threshold is associated with a delay-related configuration, and the second threshold is smaller than the first threshold.

Example 27 includes the method of any of examples 23-26 or some other example herein, wherein the configuration is included in a radio resource control (RRC) configuration signaling.

Example 28 includes the method of any of examples 23-27 or some other example herein, wherein the one or more parameters include the first threshold and an offset value, and the method further including: obtaining the second threshold based on the first threshold and the offset value.

Example 29 includes the method of any of examples 23-28 or some other example herein, wherein: said determining whether the RLC SDU is associated with a first importance level or a second importance level includes: determining that the RLC SDU is associated with the first importance level; and said configuring the retransmission counter associated with the RLC SDU includes: configuring the maximum retransmission threshold of the retransmission counter associated with the RLC SDU with the first threshold.

Example 30 includes the method of any of examples 23-29 or some other example herein, wherein: said determining whether the RLC SDU is associated with a first importance level or a second importance level includes: determining that the RLC SDU is associated with the second importance level; and said configuring the retransmission counter associated with the RLC SDU includes: configuring the maximum retransmission threshold of the retransmission counter associated with the RLC SDU with the second threshold.

Example 31 includes the method of any of examples 23-30 or some other example herein, further including: identifying a number of retransmissions of the RLC SDU associated with the retransmission counter; determining that the number of retransmissions of the RLC SDU is less than the maximum retransmission threshold; processing a discard notification associated with the RLC SDU, the discard notification received from a higher layer; and removing the RLC SDU from being considered for retransmission based on the notification.

Example 32 includes the method of any of examples 23-31 or some other example herein, further including: determining that a positive acknowledgment associated with the RLC SDU is not received; identifying a number of retransmissions of the RLC SDU associated with the retransmission counter; determining that the number of retransmissions of the RLC SDU is less than the maximum retransmission threshold; and retransmitting the RLC SDU based on the said determining that a positive acknowledgment associated with the RLC SDU is not received and said determination that the number of retransmissions of the RLC SDU is less than the maximum retransmission threshold.

Example 33 includes the method of any of examples 23-32 or some other example herein, further including: identifying a number of retransmissions of the RLC SDU associated with the retransmission counter; determining that the number of retransmissions of the RLC SDU is equal to the maximum retransmission threshold; and performing an operation based on said determining that the number of retransmissions of the RLC SDU is equal to the maximum retransmission threshold.

Example 34 includes the method of any of examples 23-33 or some other example herein, wherein said performing the operation includes: considering the RLC SDU is positively acknowledged; removing the RLC SDU from being considered for retransmission; generating a first message to be transmitted to an upper layer, the first message to indicate that the number of retransmissions of the RLC SDU reached the maximum retransmission threshold and that a positive acknowledgment associated with the RLC SDU was not received; generating a second message to be transmitted to a lower layer, the second message to indicate that the number of retransmissions of the RLC SDU reached the maximum retransmission threshold and that a positive acknowledgment associated with the RLC SDU was not received; generating a third message to be transmitted to a peer RLC receiving entity, the third message to indicate that the number of retransmissions of the RLC SDU reached the maximum retransmission threshold and that a positive acknowledgment associated with the RLC SDU was not received; triggering a poll by setting a polling flag in a protocol data unit (PDU); or considering that the RLC SDU is negatively acknowledged.

Example 35 includes the method of any of examples 23-34 or some other example herein, further including: detecting a condition, wherein said performing the operation is based further on said detecting the condition.

Example 36 includes the method of any of examples 23-35 or some other example herein, wherein detecting the condition includes detecting whether: congestion is detected on a data radio bearer (DRB) associated with the RLC SDU; an importance-based packet discarding is activated on the DRB associated with the RLC SDU; the RLC SDU is associated with an important protocol data unit (PDU) set; a buffered data volume exceeds a first threshold; a buffered data volume of one or more RLC SDUs associated with a delay-related attribute exceeds a second threshold; a transmitting window of a transmitting entity is stalled; or a sequence number gap between two acknowledged RLC SDUs exceeds a third threshold.

Another example may include an apparatus comprising means to perform one or more elements of a method described in or related to any of examples 1-36, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Another example may include an apparatus comprising logic, modules, or circuitry to perform one or more elements of a method described in or related to any of examples 1-36, or any other method or process described herein.

Another example may include a method, technique, or process as described in or related to any of examples 1-36, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-36, or portions thereof.

Another example may include a signal as described in or related to any of examples 1-36, or portions or parts thereof.

Another example may include a datagram, information element, packet, frame, segment, PDU, or message as described in or related to any of examples 1-36, or portions or parts thereof, or otherwise described in the present disclosure.

Another example may include a signal encoded with data as described in or related to any of examples 1-36, or portions or parts thereof, or otherwise described in the present disclosure.

Another example may include a signal encoded with a datagram, IE, packet, frame, segment, PDU, or message as described in or related to any of examples 1-36, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-36, or portions thereof.

Another example may include a computer program comprising instructions, wherein execution of the program by a processing element is to cause the processing element to carry out the method, techniques, or process as described in or related to any of examples 1-36, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying a radio link control (RLC) service data unit (SDU) for retransmission;
determining whether the RLC SDU is associated with a delay-related attribute; and
configuring a retransmission counter associated with the RLC SDU based on said determining whether the RLC SDU is associated with the delay-related attribute.

2. The method of claim 1, further comprising:
processing a configuration including one or more parameters to obtain a first threshold and a second threshold, the first and second thresholds associated with a maximum retransmission threshold of the retransmission counter.

3. The method of claim 2, wherein the first threshold is associated with a non-delay-related configuration, the second threshold is associated with a delay-related configuration, and the second threshold is smaller than the first threshold.

4. The method of claim 2, further comprising:
obtaining the second threshold based on the first threshold and an offset value, wherein the one or more parameters include the first threshold and the offset value; or
obtaining the second threshold based on the first threshold and a fraction value, wherein the one or more parameters include the first threshold and the fraction value.

5. The method of claim 2, wherein:
said determining whether the RLC SDU is associated with a delay-related attribute includes:
determining that the RLC SDU is not associated with the delay-related attribute; and
said configuring the retransmission counter associated with the RLC SDU includes:
configuring the maximum retransmission threshold of the retransmission counter associated with the RLC SDU with the first threshold.

6. The method of claim 2, wherein:
said determining whether the RLC SDU is associated with a delay-related attribute includes:
determining that the RLC SDU is associated with the delay-related attribute; and
said configuring the retransmission counter associated with the RLC SDU includes:
identifying a remaining time until discarding associated with the RLC SDU;
selecting or determining a third threshold based on the remaining time until discarding associated with the RLC SDU; and
configuring the maximum retransmission threshold of the retransmission counter associated with the RLC SDU with the third threshold.

7. The method of claim 2, wherein:
said determining whether the RLC SDU is associated with a delay-related attribute includes:
determining that the RLC SDU is associated with the delay-related attribute; and
said configuring the retransmission counter associated with the RLC SDU includes:
configuring the maximum retransmission threshold of the retransmission counter associated with the RLC SDU with the second threshold.

8. The method of claim 7, further comprising:
identifying a number of retransmissions of the RLC SDU associated with the retransmission counter;
determining that the number of retransmissions of the RLC SDU is less than the maximum retransmission threshold;
processing a discard notification associated with the RLC SDU, the discard notification received from a higher layer; and
removing the RLC SDU from being considered for retransmission based on the notification.

9. The method of claim 7, further comprising:
determining that a positive acknowledgment associated with the RLC SDU is not received;
identifying a number of retransmissions of the RLC SDU associated with the retransmission counter;
determining that the number of retransmissions of the RLC SDU is less than the maximum retransmission threshold; and
retransmitting the RLC SDU based on the said determining that a positive acknowledgment associated with the RLC SDU is not received and said determination that the number of retransmissions of the RLC SDU is less than the maximum retransmission threshold.

10. The method of claim 7, further comprising:
identifying a number of retransmissions of the RLC SDU associated with the retransmission counter;
determining that the number of retransmissions of the RLC SDU is equal to the maximum retransmission threshold; and
performing an operation based on said determining that the number of retransmissions of the RLC SDU is equal to the maximum retransmission threshold.

11. The method of claim 10, wherein said performing the operation comprises:
considering the RLC SDU is positively acknowledged;
removing the RLC SDU from being considered for retransmission;
generating a first message to be transmitted to an upper layer, the first message to indicate that the number of retransmissions of the RLC SDU reached the maximum retransmission threshold and that a positive acknowledgment associated with the RLC SDU was not received;
generating a second message to be transmitted to a lower layer, the second message to indicate that the number of retransmissions of the RLC SDU reached the maximum retransmission threshold and that a positive acknowledgment associated with the RLC SDU was not received;
generating a third message to be transmitted to a peer RLC receiving entity, the third message to indicate that the number of retransmissions of the RLC SDU reached the maximum retransmission threshold and that a positive acknowledgment associated with the RLC SDU was not received;
triggering a poll by setting a polling flag in a protocol data unit (PDU); or
considering that the RLC SDU is negatively acknowledged.

12. The method of claim 10, wherein said performing the operation comprises;
identifying a remaining time until discarding associated with the RLC SDU;
identifying a remaining radio resource available to the RLC SDU; and
determining whether to continue with one or more additional retransmissions.

13. The method of claim 10, further comprising:
detecting a condition, wherein said performing the operation is based further on said detecting the condition.

14. The method of claim 13, wherein detecting the condition comprises detecting whether:
congestion is detected on a data radio bearer (DRB) associated with the RLC SDU;
an importance-based packet discarding mechanism is activated on the DRB associated with the RLC SDU;
the RLC SDU is associated with an important protocol data unit (PDU) set;
a buffered data volume exceeds a first threshold;
a buffered data volume of one or more RLC SDUs associated with a delay-related attribute exceeds a second threshold;
a transmitting window of a transmitting entity is stalled; or
a sequence number gap between two acknowledged RLC SDUs exceeds a third threshold.

15. An apparatus comprising:
processing circuitry to:
generate a configuration to be transmitted and configure a user equipment (UE), the configuration including one or more parameters associated with a first threshold and a second threshold, the first and second thresholds associated with a maximum retransmission threshold of a retransmission counter, the retransmission counter associated with a radio link control (RLC) entity of the UE; and
process RLC protocol data units (PDUs) received from the UE and consistent with the configuration; and
interface circuitry coupled with the processing circuitry to enable communication.

16. The apparatus of claim 15, wherein:
the first threshold is associated with non-delay-critical RLC SDUs and the second threshold is associated with delay-critical RLC SDUs;
the configuration includes the first threshold and an offset value;
the configuration includes the first threshold and a fraction value; or
the configuration is an information element of an RLC configuration in radio resource control (RRC) configurations.

17. One or more non-transitory computer-readable media having instructions that, when executed, cause processing circuitry to:
identify a radio link control (RLC) service data unit (SDU) for retransmission;
determine whether the RLC SDU is associated with a first importance level or a second importance level; and
configure a retransmission counter associated with the RLC SDU based on the determination of whether the RLC SDU is associated with the first importance level or the second importance level; and
process a configuration including one or more parameters to obtain a first threshold and a second threshold, the first and second thresholds associated with a maximum retransmission threshold of the retransmission counter.

18. The one or more non-transitory computer-readable media of claim 17, wherein the first threshold is associated with the first importance level, the second threshold is associated with the second importance level, and the second threshold is smaller than the first threshold.

19. The one or more non-transitory computer-readable media of claim 17, wherein the one or more parameters include the first threshold and an offset value, and the instructions, when executed, further cause the processing circuitry to:
obtain the second threshold based on the first threshold and the offset value.

20. The one or more non-transitory computer-readable media of claim 17, wherein the instructions, when executed, further cause the processing circuitry to:
identify a number of retransmissions of the RLC SDU associated with the retransmission counter;
determine that the number of retransmissions of the RLC SDU is less than the maximum retransmission threshold;
process a discard notification associated with the RLC SDU, the discard notification received from a higher layer; and
remove the RLC SDU from being considered for retransmission based on the notification.
